(19) United States
(12) Patent Application Publication
(10) Pub. No.: US 2006/0283666 A1
(43) Pub. Date: Dec. 21, 2006

(54) Flexible ladder with supporting accessory

(76) Inventor: Ze-peng Zhou, Guangdong (CN)

Correspondence Address: Michael G Crilly, 104 South York Road, Hatboro, PA, 19040, US

(21) Appl. No.: 10/567,706

(22) PCT Filed: Oct. 21, 2003
(86) PCT No.: PCT/CN03/00878

§ 371 Date: Feb. 7, 2006

(30) Foreign Application Priority Data
Aug. 8, 2003 (CN) 03261042.4

(51) Int. Cl. E06C 1/36; E06C 1/52

(52) U.S. Cl. 182/206; 182/196

(57) ABSTRACT

A rope ladder with support attachments is presented. The invention includes a hook, allowing the invention to be hung from a building, a rope ladder body, comprising a pair of belt rails and multiple rungs disposed between the belt rails attached to the hook, and support attachments symmetrically fixed onto the inside surface of the belt rails at joints between rails and rungs. Each support attachment is of a folding design with torsion spring so that the support attachment automatically opens outward until the inner angle between the support attachment and rung is slightly larger than 90 degrees. Support attachments provide a gap between belt rails and the wall of a building. The present invention ensures a suitable gap between rungs disposed along the length of the rope ladder and building wall so as to allow the user to easily, reliably and properly step onto each rung of the rope ladder.

### CROSS REFERENCE TO RELATED APPLICATIONS

This application claims priority to PCT Application No. PCT/CN03/00878 filed on Oct. 21, 2003, which is hereby incorporated in its entirety by reference thereto.

### FEDERALLY SPONSORED RESEARCH AND DEVELOPMENT

None.

### BACKGROUND OF THE INVENTION

1. Field of the Invention

The present invention is generally related to a rope ladder facilitating escape from a building during an emergency.

2. Description of the Related Art

Presently known rope ladders are made of soft textile belts sown together to form side rails and rungs. Several deficiencies are noteworthy. Rails and rungs twist and deform when the weight of a person is applied onto the rungs of the ladder. Known rope ladders hang close to or against the building, thus providing a narrow gap there between which prevents the user from properly stepping onto each rung of the ladder. As such, known rope ladders are difficult to use, thus extending the time required to traverse the length of the ladder and slowing escape from a building.

### SUMMERY OF INVENTION

An object of the present invention is to provide a rope ladder with support attachments that allows the user to easily, reliably and properly step onto each rung of the rope ladder. The object of the invention is achieved by the technical features of the design.

The present invention, namely, a rope ladder with support attachments, includes a ladder hook allowing the ladder to be hung onto a building and a rope ladder body fixed to the hook. The rope ladder further includes a pair of vertically disposed and parallel flexible belt rails having a plurality of rigid rungs disposed between and attached to the belt rails in a perpendicular fashion. A support attachment is separately fixed onto the back surface of each belt rail at the joint between belt rails and rung in a paired and symmetrical fashion. The design of the present invention ensures that rope ladder and building are separated by the support attachments, thus allowing the user to step onto the rungs along the ladder.

Support attachments are of a folding design whereby each includes a base plate fixed to the joint including belt rail and rung along the rope ladder and a spacer plate articulated with respect to the base plate by way of a pivot pin. The pivot pin resides within a torsion spring, the force of which is sufficient to automatically and outwardly open the spacer plate until contact occurs between a stop along the spacer plate and a pair of bosses along the base plate. When openly deployed, each spacer plate forms an internal angle slightly larger than 90 degrees with respect to the rungs. This arrangement prevents the spacer plate from closing when a user steps on the rung. The foldable nature of the support attachments allows them to be closed when the rope ladder is coiled, thus reducing the space required for storage.

The hook includes a U-shaped hook body and two L-shaped hooks disposed about and attached thereto. The U-shaped hook body has a horizontal bar located at each end of the vertical bars comprising the U-shaped structure. Each L-shaped hook comprises a vertical bar and a horizontal bar, the latter having two bolts fixed and projecting there from. The horizontal bars along the hook body have a plurality of through holes which align with the bolts projecting from the L-shaped hook so as to facilitate adjustment to the spacing between rope ladder and building during use. Bolts along the L-shaped hooks are aligned with and inserted through the holes along the horizontal bars of the U-shaped hook body. Thereafter, butterfly nuts are screwed onto the bolts so as to secure the L-shaped hooks to the U-shaped hook body. The adjustability provided by the U-shaped hook body allows the present invention to be adapted to a variety of wall thicknesses and structures. Support attachments are either attached to each belt rail and rung joint along the rope ladder or assembled in a paired arrangement equally spaced every third or fourth rung.

Rungs are comprised of an aluminum alloy, in order to avoid deformation of the rope ladder when supporting the weight of a user, and have a fire-retardant textile cloth outer wrap.

The primary advantage of the present invention is that the rope ladder maintains its ladder shape and sufficient spacing from the structure onto which it is attached so as to allow the user to traverse the length of the rope ladder in a safe manner.

### REFERENCE NUMERALS

1 Hook 43 Pivot pin
2 Belt rail 44 Torsion spring
3 Rung 111 Horizontal bar
4 Support attachment 112 Through hole
11 U-shaped hook body 121 Horizontal bar
12 L-shaped hook 122 Vertical bar
13 Butterfly nut 123 Bolt
41 Base plate 411 Boss
42 Spacer plate 412 Stop

### BRIEF DESCRIPTION ON DRAWINGS

The invention will now be described in more detail, by way of example only, with reference to the accompanying drawings, in which:

FIG. 1 is a front elevation view of the present invention showing the rope ladder with support attachments.

FIG. 2 is a right-side elevation view of the present invention showing the rope ladder with support attachments.

FIG. 3 is a perspective view of the hook with partial exploded view.

FIG. 4 is a perspective view of the support attachment with partial exploded view.

### DETAILED DESCRIPTION OF THE INVENTION

A more detailed description of the present invention is provided below in combination with the attached drawings.

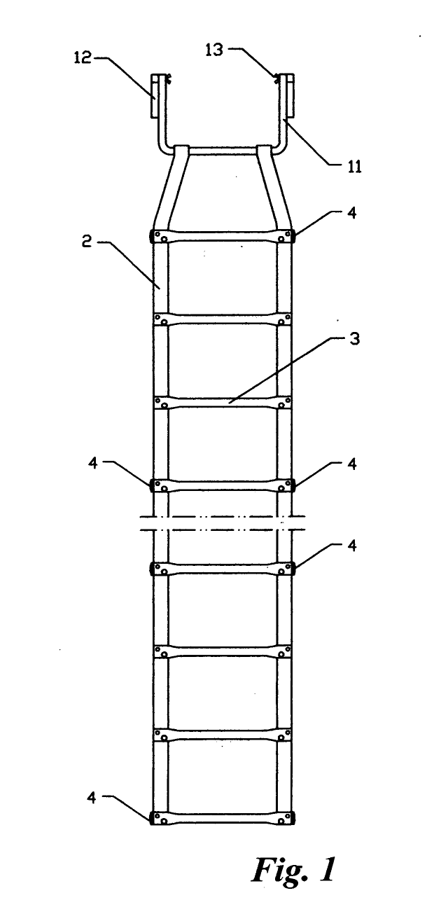

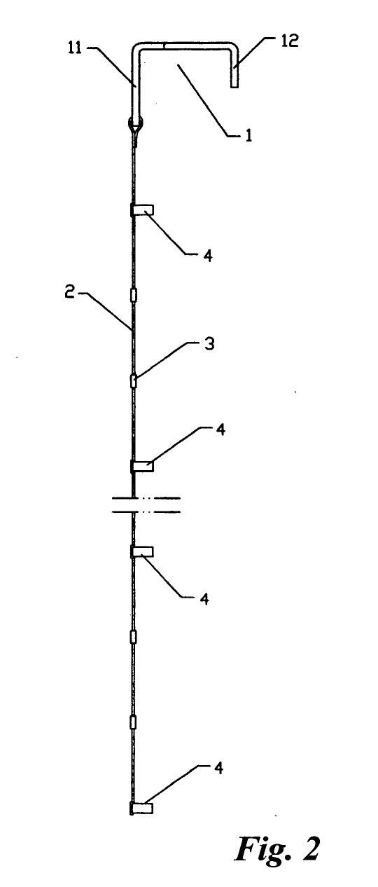

Referring now to FIGS. 1-2, the present invention is a rope ladder with support attachments 4, comprising a hook 1 that is attachable to a building, a ladder body including a pair of flexible belt rails 2 attached to the hook 1, a plurality of rungs 3 spanning the belt rails 2, and support attachments 4 symmetrically located on the back surface of the belt rails 2. The support attachments 4 are assembled onto joints between belt rails 2 and rungs 3.

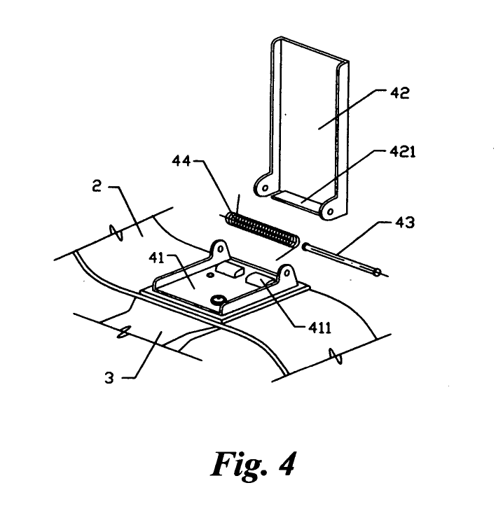

Referring now to FIG. 4, support attachments 4 are made of a metallic material in a folding design, comprising a base plate 41 that is riveted to the joint between rungs 3 and belt rails 2, and a spacer plate 42 that is connected to the base plate 41 by way of a pivot pin 43. The pivot pin 43 resides within a torsion spring 44 which applies a force onto the spacer plate 42 so that it automatically opens outward until the stop 421 disposed along one end of the spacer plate 42 contacts the bosses 411 projecting from the base plate 41. The inner angle between the opened spacer plate 42 and rung 3 is slightly larger than 90 degrees, which prevents the spacer plate 42 from closing during use while providing the maximum space required to step on the rung 3.

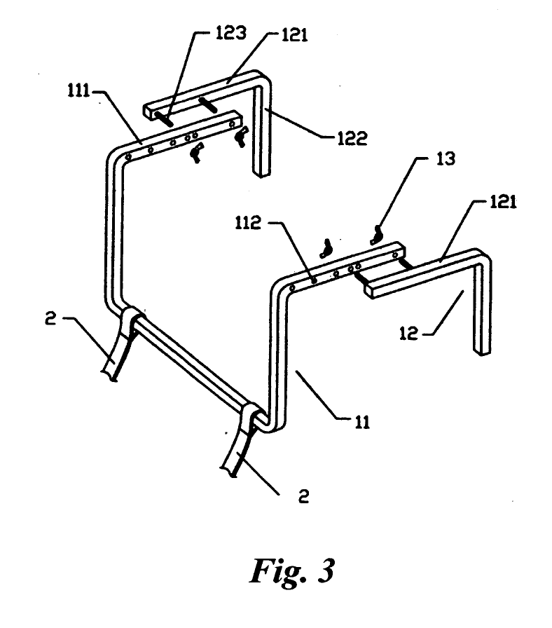

Referring now to FIG. 3, the hook 1 comprises two L-shaped hooks 12, each formed by a horizontal bar 121 and vertical bar 122, disposed about and attached to a U-shaped hook body 11. The U-shaped hook body 11 has a horizontal bar 111 disposed at each end of the vertical elements comprising the U-shaped portion of the U-shaped hook body 11. Horizontal bars 111 are disposed so as to project in the same direction as the spacer plates 42. Two bolts 123 are fixed to the inside of each vertical bar 121. A row of through holes 112 are provided along each horizontal bar 111. Bolts 123 along each of the horizontal bars 121 are inserted into respective pairs of through holes 112. A butterfly nut 13 is threaded onto each bolt 123 to completely secure and fix the L-shaped hooks 12 to the U-shaped hook body 11. Butterfly nuts 13 are easily tightened manually without the use of tools. The described arrangement of through holes 112 and bolts 123 allows the user to adjust the distance between the vertical bars 122 and U-shaped portion of the U-shaped hook body 11 so as to accommodate various wall thicknesses and designs.

One support attachment 4 may be assembled either onto each joint formed between belt rails 2 and rungs 3 or onto selected rungs 3 including repeating patterns such as every third or fourth rung 3.

Rungs 3 are preferred to be composed of an aluminum alloy material that is lightweight but sufficiently strong to support the weight of a user and having a round cross-section within the stepping region of the rung 3 and a flat cross-section where the rung 3 is attached to the belt rails 2. The rigid nature of the rungs 3 prevents deformation thereof, thereby facilitating climbing. A layer of fire-retardant braided textile may be wrapped around the exterior of the aluminum alloy rungs 3. Fire-retardant bands are sown together with nylon threads to enhance the friction force between rungs 3 and bands so as to properly secure the bands to the rungs 3.

Proper use of the rope ladder includes the following steps. The user adjusts the width of the hook 1 by positioning the bolts 123 within the appropriate through holes 112 so that the vertical elements along the U-shaped hook body 11 contact the outwardly disposed surface of a wall or structure and the vertical bars 122 contact the inwardly disposed surface of the same wall or structure. Thereafter, butterfly nuts 13 are tightened to fix the hook 1 to the structure and the ladder body is lowered. Spacer plates 42 within support attachments 4 are automatically opened by the torsion springs 44. The spacer plates 42 contact the wall or structure, thereby maintaining a suitable space between wall or structure and the rungs 3 and belt rails 2, thus allowing the user to step onto each rung 3 while avoiding contact with the wall or structure.

What is claimed is:

1. A rope ladder facilitating escape from a building during an emergency comprising:
(a) a hook; and
(b) a ladder body comprising:
(i) a pair of flexible belt rails disposed in a parallel fashion and each fixed at one end to said hook;
(ii) a plurality of rungs disposed between and separately attached to said belts rails; and
(iii) a plurality of support attachments symmetrically fixed onto the back of said belts rails, said support attachment attached where said rungs are attached to said belt rails

2. The rope ladder of claim 1, wherein each said support attachment comprises:
(1) a base plate fixed where said rung is attached to said belt rail; and
(2) a spacer plate that articulates relative to said base plate via a pivot pin residing within a torsion spring which connects said base plate to said spacer plate, said torsion spring rotating said spacer plate until a stop along said spacer plate contacts a positioning limiting boss on said base plate, said spacer plate at an angle larger than 90 degrees with respect to said base plate when deployed by said torsion spring.

3. The rope ladder as in claim 1 or 2, wherein said hook comprises:
(1) a U-shaped hook body and two L-shaped hooks, said U-shaped hook body having a pair of first horizontal bars disposed about and attached to a vertical U-shaped element, said L-shaped hooks each having a vertical bar attached to a second horizontal bar, each said first horizontal bar having a plurality of holes and each said second horizontal bar having two bolts projecting there from and aligned to pass through two of said holes, each said L-shaped hook attached to said U-shaped hook body by tightening a butterfly nut onto each of said bolts.

4. The rope ladder as in claim 1 or 2, wherein said support attachments are provided at each said rung.

5. The rope ladder as in claim 1 or 2, wherein said support attachments are provided at every third or forth said rung.

6. The rope ladder as in claim 1 or 2, wherein said rungs are comprised of an aluminum alloy having a fire-retardant textile band thereon.
